(19) United States
(12) Patent Application Publication
(10) Pub. No.: US 2008/0132632 A1
(43) Pub. Date: Jun. 5, 2008

(54) Absorbent compositions with clay aerogels and methods for forming absorbent compositions

(76) Inventors: David A. Schiraldi, Shaker Heights, OH (US); Matthew D. Gawyrla, Port Matilda, PA (US); Suheel A. Bandi, Lakewood, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 12/012,248

(22) Filed: Feb. 1, 2008

Related U.S. Application Data
(63) Continuation-in-part of application No. 11/713,189, filed on Mar. 2, 2007.
(60) Provisional application No. 60/778,213, filed on Mar. 2, 2006.

(51) Int. Cl. C08K 3/34

(52) U.S. Cl. 524/445

(57) ABSTRACT

Lightweight, highly absorbent compositions including clay aerogels are suitable for use in the home as well as in industry and have particular suitability for use as animal litter. The compositions can further include components, for example as part of the mixture and/or as a coating on a surface of the clay aerogel component, that have properties, for example, that aid in malodor reduction, clumping, or the like, or combinations thereof. Also, clay aerogel polymer composites, formed from various types of clay and (co)polymers, which are relatively low density materials having myriad applications are disclosed. Numerous methods for preparing the clay aerogel polymer composites are disclosed.

### CROSS-REFERENCE

This application claims the benefit and priority filing dates of U.S. application Ser. No. 11/713,189 filed Mar. 2, 2007 and U.S. Provisional Application Ser. No. 60/778,213 filed Mar. 2, 2006, all herein fully incorporated by reference.

### FIELD OF THE INVENTION

The present invention relates to lightweight, highly absorbent compositions including clay aerogels. The compositions are suitable for use in the home as well as in industry and have particular suitability for use as animal litter. The compositions can further include components, for example as part of the mixture and/or as a coating on a surface of the clay aerogel component, that have properties, for example, that aid in malodor reduction, clumping, or the like, or combinations thereof. The present invention also relates to clay aerogel polymer composites, formed from various types of clay and (co)polymers, which are relatively low density materials having myriad applications. Numerous methods for preparing the clay aerogel polymer composites are disclosed. In a preferred embodiment, the clay aerogel polymer composites are formed using a freeze-drying process. Structures and compositions including the clay aerogel polymer composites are also described. In a preferred embodiment, the clay aerogel polymer composites are derived from a clay, polymer and binder component that provides the composite with increased toughness and durability. Ceramic structures derived from the composites are also described.

### BACKGROUND OF THE INVENTION

There is a need for lightweight, highly absorbent materials for use in the home as well as in industry. Absorbent materials are used, for example, to absorb liquid such as animal waste. As a large number of domestic animals are kept as house pets, there is a need for lifter wherein the animals may discharge waste, either liquid or solid, indoors in a controlled location. The waste discharge can lead to malodor production, which is offensive to some humans.

Many types of materials are used as animal lifter. Clay and various cellulose materials are used, see U.S. Pat. Nos. 5,176,108; 5,347,950; 5,503,111; 5,975,019; 5,992,351; 6,287,550; 6,887,570 and U.S. Patent Application Publication No. 2005/0175577, all herein incorporated by reference. When clay materials are utilized, lifter compositions can be quite heavy. For example, densities of some compositions used as cat lifter can range from 0.5 g/cm³ to about 1.5 g/cm³ which leads to relatively heavy containers for people to carry and store. Moreover, shipping such relatively heavy material wastes resources and can be expensive.

Various types of clays are widely available around the world. Some types of clays are layered or smectic clays that can be subdivided into individual layers. Such clays have been used in an attempt to reinforce polymers. Through some combination of mechanical reinforcement and selected crystallization of thermodynamically disfavored forms of the polymers, significantly enhanced thermal and/or mechanical properties are obtained when compared to the unfilled starting polymers or their more traditionally filled composites. In most cases, however, clay reinforcement of polymers does not result in property enhancement. One reason for sub-par performance is that to achieve useful exfoliation of the clay, the favorable thermodynamics which led to the clay's formation in nature must be overcome, and few polymer systems can provide such a thermodynamic driving force.

In an attempt to provide materials with beneficial properties, inorganic materials such as silicas, clays, metal oxides and the like have been formed into aerogels.

The production of inorganic aerogels from silica and water was first reported by S. S. Kistler, see “Coherent Expanded Aerogels”, J. Phys. Chem. 1932; 36: 52-64. In this initial process, water was slowly removed from an aqueous silica mixture via a solvent exchange process using ethanol or ether to produce low density structures. The preparation of montmorillonite clay aerogels by freeze-drying clay hydrogels was reported by R. C. MacKenzie, see “Clay-water Relationships”, Nature 1952: 171: 681-3, and F. Call, “Preparation of Dry Clay-Gels by Freeze-Drying”, Nature 1953; 172: 126; the resultant fibrous montmorillonite structures were described as possessing reasonable rigidity, but poor thermal stability at 110° C. for extended time or when desiccated over phosphorus pentoxide. Similar processing of non-swelling clays, such as kaolin, only produced fine powders.

Weiss et al., see “The Skeleton Structure in Thixotropic Gels”, Naturwissenschaften 1952; 39: 351-2, and Hoffman et al., see “A Thixotropy in Kaolinite and Inner-Crystalline Swelling in Montmorillonite”, Kolloid-Z, 1957; 151, 97-115, studied several clay-solvent combinations that produced rapid setting, thixotropic gels. These authors demonstrated that high vacuum sublimation of frozen thixotropic clay gels in water or benezene produced “gel skeletons” with remarkable elasticity (elastic compression up to 75% of their original volumes). Montmorillonite interlayer spacings, measured by x-ray diffraction, were shown to inversely correlate thixotropic and sedimentation volumes. Weiss proposed that high thixotropic volumes of montmorillonite solutions containing alkali ions were caused by a splitting of the montmorillonite crystal into thin layers.

The effects of freeze-drying on the interlayer spacing of clay hydrogels was studied in greater depth by K. Norrish et al, see “Effect of Freezing on the Swelling of Clay Minerals”, Clay Miner, Bull. 1962; 5: 9-16. Although montmorillonite clay hydrogels were found to retain their shape and partial rigidity when water was removed the interlayer spacing in sodium montmorillonite decreased from greater than 30 to 10 Å during freezing. Upon thawing, the original clay morphology was restored. Ice crystal formation was thought to be responsible for the collapse of the swollen structure, thus defining a mechanism for structural transformation, but the structure of the gel itself remained elusive.

H. Van Olphen, “Polyelectrolyte Reinforced Aerogels of Clays-Application as Chromatographic Adsorbents”, Clay Miner, 1967; 15: 423-35, proposed that particles within clay aerogels, produced using a freeze-drying process, are linked edge-to-face much like a “house of cards” owing to opposite surface and edge charges that exist in clays. The author suggested ice crystals grow radially, pushing clay particles aside to promote parallel platelet alignment. The incorporation of polyelectrolytes into bentonite clay aerogels via freeze-drying of a polyelectrolyte-bentonite hydrogel was also studied by Van Olphen, who found the normally fragile aerogels to become stronger and tougher upon polyelectrolyte incorporation.

The effects of process parameters, such as clay concentration and freezing rates, upon the size and shape of resultant clay aerogels was investigated by Nakazawa et al., see “Texture Control of Clay-Aerogel Through the Crystallization Process of Ice”, Clay Sci. 1987; 6: 269-76, who reported that decreases in clay concentrations and freezing rates resulted in pore shape changes from polygonal cells to thin lenses. The authors proposed that pores remaining in the freeze-dried aerogel structure are “negatives” of the ice particles once formed and later sublimed. The aerogels produced by Nakazawa were reportedly stable to heat treatment up to 800° C., albeit with some shrinkage.

U.S. Pat. No. 2,093,454 to Kistler relates to reported improvements in the art and process of producing dry gels from colloidal solutions, and to the production of a gel, one continuous phase of which is a gas, and which Kistler defines as an aerogel. Kistler states that the aerogels are characterized by the fact that they are formed from colloidal gels in which the liquid menstruum is removed, at least in part, by heating the liquid under pressure beyond its critical temperature, and subsequently releasing the liquid thus heated. In this manner it is possible to produce a skeleton of the solid component of the gel as it actually exists before treatment and differing only in that the liquid medium is displaced by a vapor or gas.

U.S. Pat. No. 3,203,903 to Van Olphen et al. relates to inorganic aerogels characterized by reportedly substantial physical stability and to a process for preparing such aerogels. Van Olphen reportedly teaches a method for preparing physically stable, mechanically strong aerogels of inorganic materials. The method comprises forming a gel of the inorganic material in which there is uniformly and intimately admixed a polymeric material which has substantial solubility in the liquid which composes the dispersing medium of the gel, then removing the dispersing medium and replacing it with a non-condensable gas phase, under conditions such that no gas-liquid interface exists in the dispersing medium during its removal. The aerogels of inorganic materials prepared in this way reportedly have been found to have substantially greater mechanical strength than the aerogels of the same inorganic materials prepared by the methods known previously. It has reportedly been found, for example, that clay aerogels, which have little physical strength when prepared according to the prior art methods, when prepared according to the process of this invention can readily be formed into different shapes and are physically strong enough to retain those shapes when subjected to physical stresses encountered during their use. This invention reportedly provides inorganic aerogels of improved strength. Van Olphen only describes the use of a polymeric material that can be introduced into a precursor gel used to form an aerogel. Column 4, lines 15-33, state that the polymeric material can be first dissolved in a liquid to be used in forming the gel and then the gel formed, or the gel can be formed, then contacted with a solution of the polymeric material in that liquid, or in a different liquid. The inventors of the present application have found that the aerogel composites produced according to the teachings of Van Olphen are relatively fragile, and typically fall apart upon handling.

As such, there is a need in the art for aerogel materials having improved physical features.

### SUMMARY OF THE INVENTION

The present invention provides absorbent compositions. The absorbent compositions include an aerogel component. The aerogel component can be a simple aerogel such as derived from an appropriate clay and a (co)polymer and/or binder or a clay aerogel-based porous ceramic such as obtained by firing the aerogels at a suitable temperature for a suitable period of time. The ceramic materials are essentially isostructural with the aerogels from which they are formed. Because of shrinkage due to ceramification, the air gaps in the structures are generally smaller, and the ceramic is denser than the corresponding unfired or unceramified structures. In a preferred embodiment, the aerogel component includes a reinforcing material such as fiber. In a further embodiment, the absorbent compositions include an aerogel and one or more of an odor-controlling effective amount of a material that inhibits the formation of odor, and a component useful as a clumping agent. The absorbent compositions can further include additives, including, but not limited to, dyes, antimicrobial agents, deodorants, fragrances, pigments, dedusting compounds, urease inhibition agents, pH adjustment agents, or the like.

Clay aerogel polymer composites are also formed according to the present invention. The composites utilize layered or smectic type clays capable of being exfoliated or sub-divided into individual layers. Many different types of monomers, polymers or copolymers can be utilized to form the composite in conjunction with the clay utilized.

Many different methods can be utilized to convert clays and polymers, copolymers or monomers into useful clay aerogel polymer composite materials. For example, in one embodiment the clay aerogel polymer composite can be produced from a solution, producing the composite in a single step. In one embodiment, the composite formed is derived from a clay, polymer and binder component. In a further embodiment, the aerogel structure can be preformed from a clay solution and a polymer dissolved in a suitable solvent can be infused into the aerogel, followed by freeze-drying to form the clay aerogel polymer composite. In yet a further embodiment, polymers can be melt processed with the aerogel to form a clay aerogel polymer composite material. In still another embodiment, monomers can be infused into the aerogel structure or aerogel precursor, and then in-situ polymerized in the presence of a binder to form a clay aerogel polymer composite.

Numerous different articles can be prepared containing the composite material. The articles listed herein include, but are not limited to, small, free-flowing particles (typically, but not limited to, about 1 to about 3 inches in length, and of many different shapes) suitable for use as a packaging material which represents an alternative to expanded polystyrene particles commonly in use at the present time. Also included are single molded parts or forms suitable for packaging of electronic components and other items similar to and as a replacement for the polystyrene foam inserts which computers or other devices come packed in. Molded parts, organized bats or free-flowing particles suitable for thermal and/or acoustical insulation, including, but not limited to, housing (walls, attic, roofing structures, pipes and ductwork), vehicles such as sound deadening panels or foams, and aircraft and spacecraft exterior and interior insulation panels are able to be prepared. Articles suitable for providing barrier to gas or liquid permeation beyond that of a simple polymeric structure and can be used in a variety of packaging and storage devices are able to be prepared. Articles suitable for providing ballistic protection, suitable for use in individual body armor, as well has vehicular protection in land, water, or aeronautic forms of transportation can also be prepared. Additional articles include filters or products (pads, bats, and loose fills, etc.) used to absorb industrial, biological, chemical, agricultural wastes and other fluids. Other, low density polymeric structures in which the clay aerogel composite is present can be used to replace polymeric foams. Laminates including the clay aerogel composite are prepared in some embodiments.

Accordingly, one aspect of the invention is to provide a clay aerogel polymer composite, comprising a clay, a (co)polymer, and a binder component, wherein the clay is present in an amount from about 1 to about 99 parts per 100 parts by weight of the composite, wherein the polymer is present in an amount from about 1 to about 99 parts by weight per 100 parts by weight of the composite, and wherein the binder component is present in an amount from about 0.1 to about 40 parts by weight per 100 parts by weight of the composite.

Another aspect of the invention is to provide a process for preparing a clay polymer aerogel composite, comprising the steps of combining a clay, a (co)polymer, a binder component and a solvent to form a composition, freezing the composition, and sublimating the composition to remove the solvent and produce the clay aerogel polymer composite.

Yet another aspect of the invention is to provide a clay aerogel polymer composite, comprising the composite derived from a composition comprising a) an aerogel derived from at least clay; b) a (co)polymer; and c) a binder component, wherein the binder component is present in the composite either before or after the aerogel is contacted with the (co)polymer.

Still another aspect of the invention is a process for preparing a clay aerogel polymer composite, comprising the steps of combining an aerogel derived from at least clay with a (co)polymer melt or solution, wherein a binder component is present in the aerogel or the melt or solution, or both prior to said combining step.

A further aspect of the invention is a clay aerogel polymer composite, comprising the composite derived from a) an aerogel derived from at least clay, b) two or more monomers that are the same or different, c) an initiator, and d) a binder component, and optionally a cross-linker, wherein the monomers are polymerized in the presence of the clay aerogel.

Another aspect of the invention is a process for preparing a clay aerogel polymer composite, comprising the steps of a) combining an aerogel derived from at least clay, b) two or more same or different monomers, c) an initiator, and d) a binder component in a solvent to form a solution; and polymerizing the monomers and removing the solvent to produce the clay aerogel polymer composite.

Still a further aspect of the invention is a clay aerogel-based porous ceramic, comprising a ceramic structure derived from an aerogel composition formed by heating to a temperature greater than or equal to 400° C. for a length of time sufficient to produce the clay aerogel-based porous ceramic.

Yet another aspect of the invention is a process for preparing a clay aerogel-based porous ceramic, comprising providing an aerogel, heating the aerogel for a sufficient period of time to a temperature above 400° C. to produce the clay aerogel-based porous ceramic.

A further aspect of the invention is an article, comprising a clay aerogel polymer composite layer and a second layer.

Yet a further aspect of the invention is a clay aerogel composite, comprising a clay, and a water soluble salt in an amount from about 0.05 to about 20 parts by weight per 100 parts by weight of the clay.

In a yet a further aspect of the present invention, an absorbent composition is provided comprising an aerogel component that is a low density material that can absorb water rapidly while remaining in particulate form without substantial degradation. The aerogel component comprises clay and one or more of a polymer and binder. The aerogel component can be utilized as formed or can be provided in a ceramic form produced by effectively firing the aerogel component.

Still a further aspect of the present invention is to provide a reinforced aerogel component, wherein the reinforcing agent is included during formation of the aerogel component such as fibers which can be inorganic or organic, either naturally organic or synthetic.

Another aspect of the invention is to provide an absorbent composition comprising an aerogel component post-treated with one or more additional components that can be utilized to enhance clumping or control odors.

Yet a further aspect of the invention is to provide methods for forming absorbent compositions including combining an aerogel component with one or more of a clumping agent, an odor control agent, dyes, antimicrobial agents, deodorants, fragrances, pigments, dedusting compounds, urease inhibition agents, pH adjustment agents, or the like. Preferred methods include spray drying one or more additive materials on the aerogel component.

In one aspect of the present invention, an absorbent composition is disclosed, comprising particles of an absorbent porous clay aerogel comprising one or more of (a) an aerogel component derived from at least a clay and one or more of (i) a (co)polymer and (ii) binder component and (b) a clay aerogel-based porous ceramic derived from at least the aerogel component; and an additive material in contact with at least one clay aerogel particle and comprising one or more of a clumping agent, an antimicrobial agent, a pH-adjusting agent, a fragrance, a deodorant, an odor-control agent, a coloring agent, a dedusting agent, a urease inhibition agent and a non-aerogel absorbent material.

In another aspect of the present invention, a reinforced clay aerogel is disclosed, comprising one or more of (a) a porous clay aerogel component derived from at least a clay, one or more fibers and one or more of (i) a copolymer and (ii) a binder component, and (b) a clay aerogel-based porous ceramic derived from the porous clay aerogel component.

### DETAILED DESCRIPTION OF THE INVENTION

Absorbent compositions provided by the present invention include a clay aerogel component. The clay aerogel component can comprise a clay and one or more of (a) a (co)polymer of two or more same or different monomers and (b) a binder component. Clay aerogels at least including a clay and a (co)polymer are refined to herein in some embodiments as clay aerogel polymer composites and it is to be understood that the same can include additional components present as part of the composite, such as described herein, e.g., a binder, fibers, etc. The absorbent compositions are useful for absorbing liquids, such as animal waste, particularly urine; or chemicals such as gasoline, motor oil, or other fluids. That said, the absorbent compositions are particularly useful as an animal litter, such as for cats. The absorbent compositions described herein are useful for many other types of uses other than as an animal litter. Such uses include, but are not limited to, filtration, bioremediation, waste clean-up, pharmaceutical applications, soaps, detergents, and other dry products.

The clay aerogel polymer composites of the invention are at least derived from a composition comprising a clay and a (co)polymer derived from one or more same or different monomers. Thus, the term polymer in clay aerogel polymer composites can refer to a polymer or copolymer, unless specifically stated otherwise. In various preferred embodiments, the composites include a binder component that generally adds or contributes, i.e. such as synergistically, beneficial properties to the composites. The clay aerogel polymer composites are low density materials possessing useful properties capable of numerous different uses.

The clays utilized to form the clay aerogels or clay aerogel polymer composites of the present invention are layered or smectic clays capable of being exfoliated or subdivided into individual layers. Clay is generally defined as a material containing a hydrated silicate of an element such as aluminum, iron, magnesium, potassium, hydrated alumina, iron oxide, or the like. The silicate layers of such clays are negatively charged, and are separated by layers of positively charged ions, such as sodium, potassium and other elements. While not specifically required for the present invention, naturally-occurring clays can be altered via ion exchange processes, to, for example, replace sodium ions with quaternary ammonium ions and utilized in the present invention. Occasionally, the clay will contain impurities of other naturally occurring minerals and elements that can vary depending on the location where the clay is obtained. The clays of interest for the present invention can be used as mined, or can be purified by methods known to those of ordinary skill in the art of clay product manufacture.

Examples of suitable clays, which generally should be soluble or dispersible in solvents such as water to at least 1-5 wt. %, include, but are not limited to, illite clays such as attapulgite, sepiolite, and allophone; smectite clays such as montmorillonite, bentonite, beidellite, nontronite, hectorite, saponite, and sauconite; kaolin clays such as kaolinite, dickite, nacrite, anauxite, and halloysite-endellite. The smectic clays and kaolinite clays are preferred as the same include a preferred layered structure.

If a desired clay does not form a substantially stable gel in solution, as is preferred for making clay aerogels, small amounts of (co)polymer or binder can be added to give the materials stability in both the wet and dry states until being transformed into a clay aerogel-based porous ceramic, by firing. The polymers and/or binders allow the possibility of creating porous ceramics from substantially non-gelling clays. Various types of monomers, polymers, or copolymers can be combined with the clays described herein to form the clay aerogel polymer composites of the present invention. Both water soluble and non-water soluble polymers can be utilized and are each preferred in different embodiments and end use applications. As described herein, various monomers can be polymerized in the presence of a clay aerogel or a clay itself to form a clay aerogel polymer composite.

Examples of water soluble polymers include, but are not limited to, natural polymers such as starches, plant gums, modified cellulosic and lignin materials, chitan, chitosan, pectin, and water soluble and dispersible proteins. Suitable starches comprise corn starch, potato starch, amaranth starch, arrowroot starch, banana starch, barley starch, cassava starch, millet starch, oat starch, rice starch, rye starch, sago starch, sorghum starch, sweet potato starch, wheat starch and yam starch.

Water soluble polyelectrolyte polymers can also be used. Suitable polyelectrolytes have more than one acidic group per molecule. By acidic group is meant not only the acid moieties such as the sulfonic acid group, the carboxyl group, the various phosphorus acid groups, phenol groups and the like, but also their salts with both monovalent and polyvalent metals, with ammonia, and with such other salt-forming groups as the various phosphonium and sulfonium groups, and also their esters. Suitable polyelectrolytes include those wherein all of the acidic groups are combined as salts and those wherein but a part of the acidic groups are combined as salts. The suitable polyelectrolytes of this type are generically described as water-soluble organic polymeric polyelectrolytes having a molecular weight of at least 10,000. Several classes of polyelectrolytes are well known. One class is that in which the polyelectrolyte is thermoplastic—that is, the class of polyelectrolytes which are substantially free from cross-linking, or potentially cross-linking, structures. The two best known subclasses of this class are wherein the essential structure is a chain of carbon atoms, acidic groupings being substituted to that chain, and those wherein the essential structure is a chain of rings, as in cellulose derivatives wherein the ring structures are cellobiose structures. Another class of genus is that which is known as the corpuscular proteins, the chief subclass being the albumins.

Examples of this subclass wherein the essential structure of the polymer is a chain of carbon atoms are the copolymers of maleic anhydride, maleic acid, salts of maleic acid, and maleic amides with any copolymerizable monoolefinic monomer, such as vinyl acetate, vinyl alkyl ethers, vinyl chloride, and isobutylene, particularly the alkali metal, ammonium and alkaline earth metal salts of said copolymers. Such polymers are described in detail in U.S. Pat. No. 2,652,323, herein incorporated by reference.

Additional polymers or copolymers that can be utilized in the present invention are derived from monomers, including, but not limited to, olefin monomers such as ethylene, propylene, 1-octene and other alpha-olefins, styrene, isoprene, butadiene and cyclic olefins, halogenated monomers such as vinyl chloride, chlorinated isoprene and vinyl or vinylidene fluoride, acrylic monomers such as acrylic acid, methacrylic acid, acrylonitrile and various acrylate and acrylamide monomers, polyamides derived from amine containing monomers, vinyl acetate, aliphatic and aromatic dialcohols, diamines, diisocyanates or dicarboxylic acids, as well as difunctional monomers such as those containing one carboxylic acid and either one alcohol or amino group, various arylene oxides, arylene sulfides or arylene sulfones, monomers having one or more epoxy groups, including but not limited to, glycidyl ether- and cyclohexane oxide-containing monomers. Also included are any of the above-listed, or similar polymers which have been modified to include polyfunctional monomers (having three or more polymerizable functional groups) capable of polymer chain branching or crosslinking. The subject polymers can be thermoplastic, thermoset, or can be thermosettable—i.e. treated with heat, radiation or chemical agents after formation of the composite structure in such a manner that the polymer is rendered thermoset after said treatment.

As described herein, in one embodiment of the present invention, two or more of the same or different monomers which are utilized to form the above described polymers or copolymers are dissolved in a suitable polymerization medium along with one or more desired clays and preferably a binder component, and the monomers are polymerized. In such cases, the composition in one embodiment includes an initiator, such as a free radical initiator and optionally a crosslinker. Suitable free radical initiators include, but are not limited to, azo compounds such as 2,2′-azobisisobutyronitrile, 4,4′-azobis(4-cyanovaleric acid), and 1,1′-azobis (cyclohexane-carbinitrile); peroxides such as benzoyl peroxide, tert-butyl peroxide, and tert-butyl hydroperoxide; Fenton's Reagent, and benzophone or other photo-initiated agents. Suitable crosslinking agents include, but are not limited to, 1,3,5-benzene tricarboxylic acid, 1,2,4 benzene tricarboxylic acid anhydride, glycerol, pentaerythritol, a polyamine such as triethylene tetramine, divinyl benzene, multifunctional isocyanates, and ethylene glycol bis(methacrylate).

Non-water soluble polymers are preferably dissolved in a suitable solvent appropriate for the polymer with examples including, but not limited to, alcohol such as methanol, ethanol, propanol, butanol, acid group containing solvents such as formic acid and acetic acid, formamide, acetone, tetrahydrofuran, methyl ethyl ketone, ethyl acetate, acetonitrile, N,N-dimethylformamide, dimethyl sulfoxide, hexane, toluene, benzene, ethers such as diethyl ether, methylene chloride, or carbon tetrachloride, etc.

The aerogel polymer composites of the present invention include clay in an amount generally from about 1 to about 99 parts, desirably from about 1 to about 40 parts, and preferably from about 1 to about 10 or 30 parts by weight based on 100 parts by weight of the aerogel polymer composite. Unless specifically stated herein, all parts are on a dry weight basis, i.e. no water or solvent, etc. The weight ratio of polymer to clay ranges generally from 1:99 to about 99:1, desirably from about 1:9 to about 9:1, and preferably from about 1:4 to about 4:1 polymer to clay. That said, the polymer is present generally in an amount from about 1 to about 99 parts, desirably from about 1 to about 60 parts, and preferably from about 1 to about 30 parts based on 100 parts by weight of the aerogel composite. The balance of the aerogel composite comprises any of the binder component, additives, fillers, etc. such as mentioned herein.

In a further embodiment, the clay aerogel component comprises a clay and a binder component. In a further embodiment, in addition to the clay and polymer components, the aerogel compositions and composites formed from the compositions include a binder component that provides the composites with additional desirable properties, such as mechanical properties and water absorption properties. In one embodiment, the binder component is a polymer or copolymer derived from two or more same or different alkylene oxide monomers having from 1 about 6 carbon atoms, such as formaldehyde (methylene oxide), ethylene oxide, propylene oxide, and butylene oxide. Examples of suitable preferred binder components include, but are not limited to, poly(vinyl alcohol), polyoxymethylene, poly(ethylene oxide), poly(propylene oxide), and poly(ethylene oxide)/(propylene oxide) (co)polymers. These (co)polymer components can also be derived from amines, such as (but not limited to) poly(ethylene imine) and can include mixed polymer systems which are composed of greater than one functionality, such as amines and alkylene oxides. An example of such a mixed system is a poly(alkylene oxide) which has amine groups at its ends—such amine/poly(alkylene oxide) materials are commercially available as surfactants. The binder component is present in the aerogel component, such as an aerogel composite, in an amount generally from about 0.1 to about 40 parts, desirably from about 0.5 to about 25 parts, and preferably from about 1 to about 10 parts by weight per 100 parts by weight of the aerogel polymer composite.

In yet a further embodiment, any water soluble salt, comprising mono-, di-, or tri-valent cations, including, but not limited to, Na, K, Li, H, Ca, Mg, and Al, and mono-, di-, or tri-valent anions, including, but not limited to, Cl, F, Br, O, S, PO₄, SO₃, SO₄, acetate, or benzoate, or combinations thereof are incorporated into the aerogel or aerogel polymer composite. These salts are preferably incorporated into the aqueous clay gel mixtures prior to freeze drying and are present in an amount from about 0.05 to about 10 or about 20 parts per 100 parts by weight of the clay aerogel or aerogel polymer composite on a dry basis, depending on the specific solubility of said salts.

These salt-modified aerogels can be produced in the presence or absence of water soluble or water dispersible polymers, and/or sizing agents. The composites produced can be used as is, or can be subjected to one or more subsequent modification steps including, but not limited to, impregnation with polymer or monomer solutions, and heat treatment to produce ceramic material.

Other fillers such as, but not limited to, non-smectic clays, talc, mica, fluoromica, glass fibers, carbon fibers, and carbon nanotubes can be incorporated in an amount up to 50 parts by weight per 100 parts of the aerogel polymer composite or aerogel component on a dry basis, preferably less than 10 parts per 100 parts of the aerogel polymer composite or aerogel component on a dry basis. The optimal amount of other filler will depend on the quantity of clay employed in the composite. Generally, as the amount of clay is increased, the amount of other filler(s) that can be advantageously added will also increase. Colorants (dyes, pigments), antistatic agents, chemical coupling agents, electrically conductive-fillers including, but not limited to, forms of conductive carbon and metal flakes/particles; and photoactive species including, but not limited to, rare earth ions, can each be incorporated into the aerogel composite structures, generally at less than 10 parts per hundred parts of the aerogel polymer composite or aerogel component, and in some cases at less than 1 part per million of the final composition by weight.

Other additives useful to modify the properties of the aerogel materials can also be utilized. When the aerogel is desired to be fired to form a ceramic material, suitable additives include ceramics and fluxes. Fluxes serve to lower the temperature at which individual clay particles bind together forming a stable ceramic body. Examples of suitable fluxes include, but are not limited to, carbonates containing lithium, magnesium, calcium, or strontium, or combinations thereof, for example soda ash Na₂CO₃; sodium tetraborate; barite or barites, such as BaSO₄; cryolite Na₃AlF₆; gypsum CaSO₄.2H₂O; lithium materials such as LiO₂; and nanoparticles such as containing nickel, cobalt, or the like. Typically less than 1 wt. % based on the total clay, and often less than 0.1 wt. %. Such fluxes are known in the literature.

In a preferred embodiment, the clay aerogel component or aerogel composite component includes one or more same or different fibers which can serve as a reinforcing agent. The addition of fibers has been found to improve the structural integrity of the aerogels, especially unfired or natural, non-clay aerogel-based porous ceramics after water or other liquid absorption. The fibers may also serve as a wicking material and aid in the uptake of fluid to the aerogel. The reinforcing fibers can be present in the natural aerogels as well as fired, clay aerogel-based porous ceramics, both the clay aerogels and aerogel polymer composites.

Fibers are in a class of materials that are generally threads or thread-like structures in discreet elongated pieces. They are utilized in the present invention as a component of the clay aerogel or aerogel polymer composites. Fibers suitable for use in the present invention include both natural fibers and synthetic fibers. Natural fibers are those produced by plants, animals, or geological processes. For example, plant fibers include, but are not limited to, cotton, hemp, jute, flax, ramie and sisal. Wood fibers derived from tree sources are also included within the scope of the present invention, including processed and unprocessed wood fibers. Animal fibers generally consist of proteins such as, but not limited to, spider silk, sinew, catgut, wool and hair such as cashmere, tunicate whiskers, mohair and angora. Mineral fibers are derived from naturally occurring minerals and include for example asbestos, woolastinite, attapulgite and halloysite. Synthetic fibers can be formed from natural or synthetic materials. Glass fibers are an example and can be made as a further example from natural raw materials such as quartz. Metal or metal oxide fibers are also suitable and can, for example, be drawn from ductile metals such as copper, gold or silver, and extruded or deposited from metals considered brittle such as nickel, aluminum or iron, for example. Carbon fibers are often based on carbonized polymers. Polymer fibers can be made from any suitable polymer including, but not limited to, polyamides, polyesters, polyolefins, polyethers, polyurethanes, polyalcohols, polyelectrolytes, polyvinyl alcohol, polyacrylonitrile and polyvinyl chloride. Fibers also include coextruded fibers having two distinct polymers forming the fiber, such as a core-sheath fiber or side-by-side fiber. Fibers also can be coated if desired. For example, coated fibers exist such as nickel-coated fibers in order to prevent static elimination, silver-coated to provide anti-bacterial properties and aluminum-coated fibers. Industrial made fibers from natural materials include soy-based fibers known as SOYSILK®, and corn-based fibers such as INGEO®. In some embodiments, various fibers present in an aerogel component that is fired, such as some polymeric fibers, can carbonize and form an interpenetrating network of carbon fibers and ceramic structures.

Cross-sectionally, any type of fibers can be utilized, including not only cross-sectionally round fibers, but also hollow, porous, oval, star-shaped or trilobal fibers, for example. Suitable fibers can be linear, curved, crimped, or the like and can be produced and/or utilized with or without added sizing agents or surface treatments.

In one embodiment, preferred fibers include those produced from polyvinyl alcohol or synthetic or naturally-occurring fibers consisting of polymers which possess high concentrations of pendant carboxylic acids, including but not limited to, polyacrylic acid and its copolymers, poly(methylacrylic acid) and its copolymers, or synthetic or naturally-occurring fibers consisting of polymer which contain significant concentrations of amide bonds, including but not limited to, Nylon-6, Nylon-6,6, silk and soy silk.

The amount of fibers and size of the fibers utilized depends upon the desired end properties of the clay aerogel component or aerogel polymer composite. The fibers utilized generally have a length from about 1 μm to about 20 mm, and preferably from about 2 mm to about 10 mm. The maximum diameter of the fibers generally ranges from about 20 nm to about 1 mm and preferably from about 15 μm to 50 μm. In order to form the desired aerogel, in one embodiment the desired fibers are placed in a solution along with the clay and one or more of (co)polymer and binder in the desired amounts such as indicated hereinabove. The fiber content of the initial solution utilized to form the desired aerogel ranges generally from about 0.001 vol. % to about 50 vol. %, and preferably from about 0.5 vol. % to about 5 vol. % based on the total volume of the solution. The amount of fibers in the formed aerogel component or clay aerogel polymer composite ranges generally from about 0.25 to about 1250 parts, and preferably from about 10 to about 100 parts based on 100 parts by weight of the clay. Similarly, stated in another manner, the fiber content when both polymer and clay are present in the clay aerogel polymer composite ranges generally from about 2.5 to about 5000 parts and preferably from about 10 to about 100 parts by weight based on 100 parts by weight of the polymer.

In one embodiment of a clay aerogel containing fibers, in the initial solution, the amount of clay ranges generally from about 0.1 to about 80 wt. %, desirably from about 2 wt. % to about 30 wt. % and preferably from about 5 wt. % to about 10 wt. % and the polymer and/or binder ranges in total amount generally from about 0 to about 90 wt. %, and preferably from about 2.5 wt. % to about 20 wt. %.

Many different methods can be utilized to convert clays and polymers, copolymers or monomers, and optionally; but often preferably a binder, into useful clay aerogel components or clay aerogel polymer composite materials which include a polymer.

For example, in one embodiment the aerogel component or composite can be produced from a polymer solution, producing the clay aerogel polymer component or composite in a single step. Forming a clay aerogel polymer component or composite in a single step offers numerous benefits including, shortened production time compared with alternative methods, as well as producing composites having property differences such as by being able to produce a more resilient, foam-like material, when compared to a two-step method. In the process, a desired amount of clay, a polymer, and/or a binder component are utilized to form a clay aerogel polymer component in a single-step per se. In a preferred embodiment, a natural polymer such as, and preferably, a starch is combined with a binder component, such as and preferably poly(vinyl alcohol) and/or poly(ethylene oxide). A general method for forming the aerogel is as follows.

In a preferred single-step method embodiment, a clay, such as montmorillonite, is mixed with a polymer, such as cornstarch by any suitable method for a period of time and then added to a solvent in which the polymer is soluble. A desired amount of a binder component is added and mixed with the clay and polymer in a preferred embodiment. For example, when cornstarch is used as a polymer, water, preferably deionized water, can be utilized as a solvent. Generally from about 1-30 wt. % solids in water is utilized. Any solvent that can be frozen into a crystalline ice, then sublimed can be used. Benzene is a representative example of a solvent other than water than can be used in other embodiments. The clay polymer solvent mixture is mixed for a period of time generally until the polymer is suspended or dissolved in the solution. In one embodiment, the solvent is heated to increase solubility of the polymer and/or binder component. The solution is blended and sheared for a period of time, such as from about 5 minutes to about 120 minutes until desired suspension is achieved. In one embodiment, a single speed blender can be utilized, such as one available from Waring. The solution is then poured or otherwise transferred into a mold. The solution in the mold is then frozen. In a preferred embodiment, the solution is frozen utilizing liquid nitrogen, although the liquid nitrogen does not contact the solution. After the solution is frozen, the mold is transferred to a freeze dryer and dried for a suitable period of time to remove the solvent. The clay aerogel polymer composite is then removed from the mold. Aerogel components can be formed utilizing clay and at least a binder using the procedure described.

An example of the one step method is as follows. A clay aerogel cornstarch polymer composite including a polyvinyl alcohol binder material was formed. 3.5 g sodium exchanged montmorillonite (PGW, Nanocor), 1.25 g polyvinyl alcohol (MW=108,000 g/mol, Polysciences Inc.), 1.25 g of corn starch (Tops Market) and 100 mL of deionized water were utilized. The polyvinyl alcohol was dissolved first in the deionized water at 100° C. and then allowed to cool to around room temperature. Then the clay/starch mixture was added to the room temperature polymer solution. The mixture was stirred by hand using a glass stir rod until all of the dry powder was suspended or dissolved in the solution. The solution was then transferred to a single speed Waring laboratory blender and sheared for 1 minute. The sheared solution was poured into glass vials (Fischerbrand, 4 DR) and frozen by submersion, up to the level of the solution, in liquid nitrogen. The vials were removed from the liquid nitrogen and placed in lyophilization shells and freeze dried for 36 hours. The dried composite was then removed by inverting the vial. Typical bulk density of the clay aerogel polymer composite is in the range of 0.04-0.07 g/cm3.

One example of forming an aerogel including a water soluble salt follows. A single speed Waring laboratory blender fitted with 1.25 L glass vessel contained 100 ml of solution containing 2 g of Closite Na+® clay and NaCl varying from 0.05 g to 1 g dispersed in 100 ml of water. This solution was sheared using a stainless steel rotor blade assembly. The mixture was blended 5 minutes, and then transferred to 600 mL freeze dryer shell. A Virtis Freeze Mobile 35EL freeze-dryer was used to sublime frozen clay hydrogels over 24 hours. Thus, after 24 hours an aerogel structure was formed. When the above experiment was conducted using 1 g NaCl, the resultant aerogel exhibited a bulk density of 0.03 g/cc. This aerogel structure was noticeably denser and firmer to the touch than the equivalent material produced in the absence of NaCl in the preparation gel solution. When examined by scanning electron microscopy, it was also observed that the spacing between layers of clay within the aerogel produced with NaCl was noticeably less than is obtained in the absence of that salt, consistent with the higher bulk density.

In a further embodiment, the clay aerogel polymer composite is formed from an aerogel preformed from a clay solution, with the aerogel being infused with a polymer in a second step from a polymer solution. In yet a further embodiment, polymers can be melt processed with the preferred aerogel to form the composite material. In still another embodiment, monomers and a binder can be infused into the aerogel structure, and then the monomers in-situ polymerized to form a clay aerogel polymer composite. In a preferred embodiment, the composites formed from aerogel and polymer includes a binder component.

In a first step, a clay aerogel is formed. One method for forming the aerogel is as follows. Other methods for forming clay aerogels have been set forth in the prior literature. A clay is dissolved or dispersed in an appropriate medium such as, but not limited to, water, preferably with mixing for a predetermined period of time. Generally, the mixture is mixed until the clay is hydrated or swelled. The clay medium mixture is transferred to an appropriate mold or vessel. Afterwards, the mixture is freeze dried generally from about 4 to about 48 hours to produce the clay aerogel. The critical point for water lies at 4.58 Torr and 0.0098° C. and below this pressure and temperature, ice is sublimed into vapor. Thus, when water is utilized as a solvent, temperature at least under 0° C. and pressure under 4.58 Torr are utilized. In one embodiment, a freeze drying system with a temperature of −35° C. under a vacuum of about 100 millitorr vacuum is utilized.

In a second step, the aerogel composite is formed by combining the aerogel with a polymer and optionally a binder. In one embodiment, the formed aerogel is soaked or immersed, or the like in a polymer melt or solution for a period of time to, optionally in the presence of a solvent such as water. The solvent, if present, is subsequently removed by evaporation or the like.

An example is as follows. 1 g of clay was dispersed in 50 ml water to which 50 ml of 5 wt. % aqueous polyvinyl alcohol solution was added. The solution is then freeze dried (at −35° C., 100 millitorr) within a cylindrical mold, and the resulting aerogel composite (A) was removed from the mold. In a beaker, 1 g of poly(ethylene glycol) (PEG) Mn˜20,000 was dissolved in 50 ml water. The previously prepared composite (A) was infused with PEG by subsequent soaking of (A) in the solution of PEG and evaporating the water under vacuum to result in composite (B); this composite consisted of an intimate combination of clay aerogel and PVA, then encapsulated in PEG. The composite produced in this manner was subjected to ordinary handling without damage, and demonstrates the ability to produce a composite with two distinct polymers present in structurally-different environments within the composite.

In a further embodiment, a clay aerogel polymer composite is produced from a clay aerogel or clay polymer aerogel such as a clay corn starch aerogel composite and an additional polymer formed in-situ from two or more same or different monomers and a binder component. In a first step, the desired monomers and binder component are dissolved in a suitable solvent to form a solution. A desired amount of clay aerogel is added to the solution. An effective amount of a free radical initiator, and optionally a crosslinking agent is/are added to the solution. The solution is heated to a suitable temperature in order to cause polymerization of the monomers as known in the art to produce a clay aerogel polymer composite. The solvent is physically removed from the aerogel structure, for example, by application of a vacuum.

The clay aerogel polymer composite material possesses many desirable properties, such as low density, desirable mechanical strength, and resiliency. The aerogel composites can be utilized alone, such as packaging materials of any desired shape and size, and are alternatives to packaging materials such as expanded polystyrene that are commonly used in the field. Complex molded shapes can also be formed utilizing the aerogel composites which are suitable for packaging of almost any articles, and have particular value in the electronics industry. The aerogel composites can be utilized in a variety of packing and storage devices and utilized for thermal and/or acoustical installation for generally any object. The aerogel composites can be utilized in components in laminates or articles for various uses. Films of the aerogel composites can be combined with other polymer films or layers or objects in one embodiment.

The numerous different types of laminates or articles containing the clay aerogel polymer component or composites of the present invention are envisioned. For example, in one embodiment the laminates or articles include at least one layer or other structure of a clay aerogel polymer component or composite and at least a second layer or other structure layer different than the clay aerogel polymer aerogel or composite. Examples of additional layers include, but are not limited to, frames, films, adhesives, fabrics, molded objects, ceramic forms or the like. The additional layer can be natural or synthetic material such as polymer or copolymer film, natural film such as those made from fibers. Any of the films can be woven or nonwoven, porous or nonporous to various components. The additional layer may include material such as paint, wood, metal and combinations thereof.

In yet a further embodiment of the present invention, clay aerogel-based porous ceramics are contemplated. When compared to the unfired aerogel, the clay aerogel-based porous ceramics have dimensions which are slightly smaller and densities which are generally higher. The clay aerogel-based porous ceramics are generally isostructural when compared to the clay aerogel or clay aerogel composite from which they are formed. Clay aerogel or clay aerogel polymer composite ceramics are formed from the aerogels by heating to an elevated temperature for a period of time in order to produce a clay aerogel-based porous ceramic. Structures remain low density (generally less than about 1.0 g/cm³), are mechanically hard, easily handled, and stable to high temperatures of use. The aerogels are generally heated to a temperature above about 400° C. for a period of time to produce the ceramic. In a preferred embodiment, the desired aerogel is placed in a suitable vessel and heated. The heat can be increased by predetermined increments such as about 50° C., 100° C., or 200° C. per hour to a final temperature such as from about 800° C. to about 1200° C., and cooled at one of the above mentioned rates after the ceramic has been formed. Stated differently, the heat applied to an aerogel composition in order to form a clay aerogel-based porous ceramic can be increased such as at a rate of about 0.5° C. or about 1° C. per minute to about 100° C. per minute and preferably from about 2° C. per minute to about 10° C. per minute. Clay aerogel-based porous ceramics are formed at temperatures generally from about 400° C. to about 1200° C., desirably about 600° C. to about 900° C., and preferably from about 850° C. to about 900° C., for periods of time which generally depend on the temperature, and can range from 0.001 minutes to about 360 minutes, and preferably from about 30 minutes to about 120 minutes. Kilns or firing furnaces are known in the art that can be utilized to prepare clay aerogel-based porous ceramics. Various different types of kilns can be utilized for example, tunnel kilns or batch kilns. Tunnel kilns are available from companies such as Harper International Corp. of Lancaster, N.Y. and Lingl of Krumbach, Germany.

An aerogel ceramic was formed in one embodiment as follows. A montmorillonite aerogel with a bulk density of about 0.5 g/cm³ was heated using a propane torch at about 1200° C. for a total of about 25 minutes.

Absorbent compositions of the present invention can include at least one clay aerogel, such as a clay aerogel component, clay aerogel polymer composite, or a ceramic clay aerogel component, or a combination thereof; and an amount of an additive material for enhancing the composition, for example, but not limited to, a material, including an antimicrobial additive, a clumping agent, a urease inhibition additive, a pH adjustment additive, a dedusting agent, a fragrance, a deodorant, a pigment, a dye, a non-aerogel absorbent, an odor-controlling additive, or a combination thereof. The one or more additives are present in an effective amount to provide a desired effect. In one embodiment, the clay aerogel is present in the absorbent compositions in an amount from about 1 to 100 parts, desirably from about 50 to about 99 parts, and preferably from about 55 to about 95 or about 97 parts by weight based on 100 total parts by weight of the absorbent composition.

An antimicrobial additive is included in the compositions of the present invention in some embodiments. Preferred antimicrobial additives are boron-containing compounds such as, but not limited to, borax pentahydrate, borax decahydrate, boric acid, polyborate, tetraboric acid, sodium metaborate, anhydrous borate, boron components of polymers, and mixtures thereof. The antimicrobial additive can be added as a solid and dry mixed into the mixture, or can be sprayed onto the particles or components in the mixture. Antimicrobial additives are preferably added in an amount of up to about 1% based on the total weight of the compositions. More descriptions regarding the use of boron-containing compounds in cat litter is found in U.S. Pat. No. 5,992,351, which is herein incorporated by reference. Some antimicrobial additives also provide an odor-controlling benefit. For example, borax, or, more accurately, di-alkali metal tetraborate n-hydrate (preferably Na₂B₄O₇xnH₂O, where n=4, 5 or 10), appears to provide multiple benefits in odor control by: (1) acting as a urease inhibitor, which controls odors by preventing enzymatic breakdown of urea; (2) having bacteriostatic properties, which appear to help control odor by controlling the growth of bacteria which are responsible for production of the urease enzymes. Antimicrobials useful in the present invention can be biocidal compounds, i.e., substances that kill microorganisms, or biostatic compounds, i.e., substances that inhibit and/or regulate the growth of microorganisms. Examples of some preferred antimicrobials are set forth in U.S. Pat. No. 6,287,550, which is incorporated by reference.

In a further embodiment, the compositions include a clumping agent, aid or additive, such as a hydrophilic polymer. Examples of suitable clumping additives include, but are not limited to, lignin sulfonate (solid), polymeric binders, fibrillated Teflon® (polytetrafluoroethylene or PTFE), and combinations thereof. Useful organic polymerizable binders include, but are not limited to, carboxymethylcellulose (CMC) and its derivatives and metal salts, guar gum cellulose, xanthan gum, starch, lignin, polyvinyl alcohol, polyacrylic acid, styrene butadiene resins (SBR), and polystyrene acrylic acid resins. Water stable composite particles can also be made with crosslinked polyester network including, but not limited to, those resulting from the reactions of polyacrylic acid or citric acid with different polyols such as glycerin, polyvinyl alcohol, lignin, and hydroxymethyl cellulose. The clumping agents, when present, can be utilized in any desired amount, generally from about 0.01% to about 5.0%, and preferably from about 0.1% to about 2% based on the total weight of the absorbent compositions.

Dedusting agents are utilized in some embodiments of the absorbent compositions including clay aerogels of the present invention. Dedusting agents such as colloidal polytetrafluoroethylene can be added to the particles in order to reduce the dust ratio. Many of the clumping aids listed above are also effective dedusting agents when applied to the outer surface of the absorbent particles. Other dedusting compounds or agents include, but are not limited to, gums, water-soluble polymeric resins, e.g., polyvinyl alcohol, polyvinyl acetate, polyvinyl pyrrolidone, polyacrylic acid, xanthan gum, gum arabic, other natural resins and mixtures of any of these resins. The dedusting agent(s), when present, are utilized in any desired amount, generally from about 0.01% to about 5.0%, and preferably from about 0.1% to about 2% based on the total weight of the absorbent compositions.

In further embodiments, the absorbent compositions include an effective amount of a material that inhibits the formation of undesirable odors and/or masks undesirable odors, i.e., a deodorant. One or more odor controlling or odor absorbing additives and/or fragrances can be utilized in the compositions of the present invention.

Activated alumina (Al₂O₃) is present in compositions in one embodiment of the present invention. Alumina is a white granular material, and is commonly called aluminum oxide. Typical aluminas include, or are derived from, gibbsite, boehmite, pseudo boehmite and bauxite, each alumina potentially having different properties. The Bayer refining process often used by alumina refineries involves four steps—digestion, clarification, precipitation and calcination. To turn bauxite into alumina, the ore is ground and mixed with lime and caustic soda. The mixture is pumped into high-pressure containers, and heated. The aluminum oxide is dissolved by the caustic soda, then precipitated out of this solution, washed, and heated to drive off water. Activated alumina is further described in U.S. Patent Publication No. 2005/0175577, herein fully incorporated by reference.

Particles of activated alumina in an effective amount can be mixed, preferably dry mixed, with other components of the absorbent composition. Preferably, the activated alumina when present in the composition, is in an amount of about 0.01% to about 50% of the composition by weight based on the total weight of the absorbent composition. More preferably, the activated alumina is present in some embodiments of compositions of the present invention in an amount of about 0.1% to about 25% by weight.

Other metals and metal salts are utilized in additional embodiments for odor control in absorbent compositions and can act as odor absorbers and/or inhibit the formation of odors. Compounds containing transition metal ions are particularly preferred in one embodiment. Suitable sources of the transition metal ions are their soluble salts. The preferred salts are silver, copper, zinc, ferric, and aluminum salts, more preferably zinc. It is also desirable that the anion provides some benefit, e.g., the anion can have the ability to provide urease inhibition, such as borate, phytate, etc. Suitable examples are silver chlorate, silver nitrate, mercury acetate, mercury chloride, mercury nitrate, copper metaborate, copper bromate, copper bromide, copper chloride, copper dichromate, copper nitrate, copper salicylate, copper sulfate, zinc acetate, zinc borate, zinc phytate, zinc bromate, zinc bromide, zinc chlorate, zinc chloride, zinc sulfate, cadmium acetate, cadmium borate, cadmium bromide, cadmium chlorate, cadmium chloride, cadmium formate, cadmium iodate, cadmium iodide, cadmium permanganate, cadmium nitrate, cadmium sulfate, and gold chloride. Other salts that have been disclosed as having urease inhibition properties include ferric and aluminum salts, especially the nitrates, and bismuth salts. Zinc salts are preferred.

Metallic salts, when added to a litter composition of the present invention such as for odor control, are present generally at a level of from about 0.001% to about 10%, desirably from about 0.01% to about 2%, and preferably from about 0.05% to about 1% by weight of the absorbent composition. When zinc salts are used as the metallic salt, it is preferable in one embodiment that the pH of the solution is adjusted to less than about 7, more preferably less than about 6, and desirably less than about 5, in order to keep the solution clear.

Other odor control additives include metal oxide nanoparticles. Additional types of odor absorbing/inhibiting additives include silica, cyclodextrin, zeolites, activated carbon, kieselguhr, chelating agents, chitin, alkali metal carbonates and bicarbonates, pH buffered materials such as carboxylic acids and the like, salt-forming materials, and mixtures thereof. Preferred materials are those which absorb primary amines. Especially preferred are cyclodextrin and/or zeolites.

In some embodiments, it is desirable to utilize fragrance in the absorbent compositions of the present invention. Fragrances are well known to those of ordinary skill in the art. Such fragrances can additionally be uncoated (e.g., fragrance blends) or encapsulated. Fragrance can be added generally in an amount up to about 10%, desirably up to about 5%, and preferably in an amount less than about 1% based on the total weight of the composition. Fragrances can include those that are aesthetically appealing to a human or that mask odor. Other fragrances include animal attractants. Additional fragrances or perfumes are described in U.S. Pat. No. 6,287,550, incorporated herein by reference.

A coloring agent such as a dye, pigment, bleach, lightener, etc. may be added to vary the color of the composition, such as to lighten the overall color of the litter so it is more appealing to an animal, aid a consumer in distinguishing the compositions from other materials, etc. For instance, suitable dyes include, but are not limited to, direct dyes, vat dies, sulfur dyes, acid dyes, mordant acid dyes, premetalized acid dyes, basic dyes, dispersed dyes, reactive dyes, azo dyes, phthalocyanine dyes, anthraquinone dye, quinoline dyes, monoazo, diazo and polyazo dyes, and suitably treated titanium dioxide. Preferred dyes include anthraquinone, quinoline and monoazo dyes. Especially preferred dyes are polymeric dyes (e.g., dyes that are covalently bonded to polymers). Illustrative pigments include phthalo pigments. Other types of color altering agents include non-staining coloring agents, especially of the type that do not stain the material to which applied until dried. Generally, the color altering agent comprises up to about 10% of the absorbent composition, desirably, 0.001% to 5% of the composition, and preferably the color altering agent comprises approximately 0.001% to 0.01% of the composition.

The absorbent compositions of the present invention in addition to the aerogel-based absorbents, can optionally include other non-aerogel absorbent materials that can be any material capable of absorbing a liquid, such as animal urine. Many liquid-absorbing materials may be used without departing from the spirit and scope of the present invention. Illustrative absorbent materials include, but are not limited to, minerals, fly ash, absorbing fibrous materials or webs, like paper, polymeric fibrous webs, wood chips, alfalfa, bark, straw, sand, absorbing pelletized materials, perlite, silicas, organics, such as cellulosic materials, other absorbent materials and mixtures thereof. Preferred minerals include: bentonites, zeolites, Fuller's earth, attapulgite, montmorillonite diatomaceous earth, opaline silica, Georgia White clay, sepiolite, calcite, dolomite, slate, pumice, tobermite, marks, attapulgite, kaolinite, halloysite, smectite, vermiculite, hectorite, fossilized plant materials, expanded perlites, gypsum and other similar materials and mixtures thereof.

Materials that exhibit urease inhibition and/or suppression herein referred to collectively as urease inhibition agents, are also suitable for use in absorbent compositions of the present invention. A partial list of materials that have been disclosed as inhibitors includes the metallic salts listed above; hydroxamic acid, modified hydroxamic and/or dihydroxyamic acids, e.g., substituted with various hydrocarbon groups such as acyl, e.g., acetochloronitrobenz-amidoaceto-, and nitrobenzamidoaceto-(e.g., 2-para), C₁₋₂₁ alkyl, aryl, and/or alkaryl groups, cycloalkyl (e.g., cyclohexyl), peptidyl, naphthyloxy-alkane, and their salts; thiourea; hydroxylamine; salts of phytic acid, especially sodium, potassium, calcium, and magnesium; extracts of plants of various species, including various tannins, e.g. carob tannin, and their derivatives such as chlorogenic acid derivatives; naturally occurring acids such as ascorbic acid, citric acid, and their salts; phenyl phosphoro diamidate/diamino phosphoric acid phenyl ester; metal aryl phosphoramidate complexes, including substituted phosphorodiamidate compounds; phosphoramidates without substitution on the nitrogen; boric acid and/or its salts, including especially, borax, and/or organic boron acid compounds; the compounds disclosed in European Patent Application 408,199, incorporated by reference; sodium, copper, manganese, and/or zinc dithiocarbamate; quinones; phenols; thiurams; substituted rhodanine acetic acids; alkylated benzoquinones; formamidine disulphide; 1:3-diketones maleic anhydride; succinamide; phthalic anhydride; pehenic acid; N,N-dihalo-2-imidazolidinones; N-halo-2-oxazolidinones; thio- and/or acyl-phosphoryltriamide and/or substituted derivatives thereof; thiopyridine-N-oxides, thiopyridines, and thiopyrimidines; oxidized sulfur derivatives of diaminophosphinyl compounds; cyclotriphosphazatriene derivatives; ortho-diaminophosphinyl derivatives of oximes; bromo-nitro compounds; S-aryl and/or alkyl diamidophosphorothiolates; diaminephosphinyl derivatives; mono- and/or poly-phosphorodiamide; 5-substituted-benzoxathiol-2-ones; N-(diarninophosphinyl)arylcarboxamides; alkoxy-1,2-benzothaizin compounds; etc. Further urease inhibitors are described in U.S. Pat. No. 6,287,550, herein fully incorporated by reference.

The urease inhibitor is optionally included in the composition of the present invention at an effective amount. The term “effective amount” as herein defined means a level sufficient to inhibit or significantly reduce the hydrolysis of urea for a specific period of time. Generally, levels of urea inhibitor are from about 0.0002% to about 5%, desirably from about 0.002% to about 0.5%, and preferably from about 0.01% to about 0.3%, by weight of the composition.

In a preferred embodiment, the absorbent compositions of the present invention comprise at least one type of clay aerogel, such as a clay aerogel component or a clay aerogel polymer composite, or a fired aerogel, namely a clay aerogel-based porous ceramic, derived from for example the aerogel component or clay aerogel polymer composite, or a combination thereof. In one preferred embodiment, the clay aerogel is in the form of particles. The particles can be formed by any method known in the art such as, but not limited to, pulverizing, dicing, or granulating. The aerogel is derived from a dispersion including a suitable clay wherein the dispersion has been freeze-dried to remove the carrier via a sublimation process thereby processing the porous aerogel. The absorbent compositions of the present invention additionally include at least one performance enhancing additive material, which generally depends on the end use of the absorbent composition. The additive material can be added to the composition in substantially any form. For example, the additive material can be added as a solid or dry mixed with the aerogel, or can be combined with the aerogel as a dispersion, for example, in one embodiment by spraying such a dispersion onto aerogel particles. The sprayed aerogel particles are preferably dried thereafter in order to form an aerogel coated with at least one additive on a surface thereof. Combining an additive dispersion with an aerogel, such as by spray drying, can provide an absorbent composition having improved physical and chemical properties. Suitable methods for forming composite particles containing an aerogel and a further substance such as an additive can be adapted from U.S. Publication Nos. 2005/0005869 and 2005/0175577, both herein fully incorporated by reference. One advantage of combining or linking the aerogel to a further substance such as an additive material is that substantially all composite particles contain a desired combination of components.

Further in view of the above, absorbent compositions can be formed by combining the aerogel and one or more additives in substantially any form. Suitable methods for creating absorbent compositions include a pan agglomeration process, a high shear agglomeration process, a low shear agglomeration process, a high pressure agglomeration process, a low pressure agglomeration process, a rotary drum agglomeration process, a mix muller process, a roll press compaction process, a pin mixer process, a batch tumble blending mixer process, an extrusion process, and a fluid bed process. Composite particles formed from at least an aerogel and an additive can be formed into any desired shape. For example, in one embodiment, composite particles are substantially spherical in shape when processed utilizing an agglomeration pan. Prior to drying, the particles can have enough moisture content that they are malleable and can be molded, for example, by compaction or other processes. A composite containing an aerogel and an additive can be made into spheres and non-spherical shapes such as, for example, ovals, flattened spheres, hexagons, triangles, squares, etc. and combinations thereof.

The absorbent compositions of the present invention include at least one form of aerogel that can be used in litter boxes or in cages of a wide variety of animals including, common pets, cats, dogs, gerbils, guinea pigs, mice and hamsters, rabbits, ferrets and laboratory animals, e.g., mice, rats and the like.

The compositions described above can be used as a “clumping” animal litter to selectively remove liquid animal wastes from the animal litter by: contacting the animal litter with liquid animal waste thereby producing an agglomerated mass (generally referred to as a “clump”) comprising the animal litter and the liquid animal waste that is of sufficient size and of sufficient clumping strength to be removed from the litter and a remaining amount of litter; and removing the clump from the remaining amount of litter. Although the clump can be removed as a wet clump, owing to the use patterns of cat owners the clump is generally removed after it has dried at room temperature for a period of about 24 hours, thereby effectively removing the liquid animal waste from the remaining amount of litter. Owing to the moisture on the surface of solid animal wastes, the instant litters are also effective in adhering to solid animal wastes. In addition, the aerogel containing animal litter can be used with litter boxes of known designs. Such litter boxes are water-impermeable receptacles having disposed therein a litter comprising a clay aerogel according to this invention and capable of agglomerating upon wetting into a clump of sufficient size and of sufficient clump strength for physical removal of the clump from the litter box. The removal of the clump is without substantial adherence to an animal, when either a wet clump or dry clump form.

As mentioned above, the compositions described herein have particular application for use as an animal litter. However, the particles should not be limited to pet litters, but rather could be applied to a number of other applications.

The compositions including at least one clay aerogel can be used as litter additives such as a formulated product that can be pre-blended with standard clumping or non-clumping clays to create a less expensive product with some of the benefits described herein. A post-additive product could also be sprinkled over or as an amendment to the litter box.

The compositions can be utilized as filters such as air or water filters that can work to eliminate a wide range of contaminants.

The absorbent compositions described herein are useful for absorbing spilled liquid such as oil spills. Absorbents with actives specifically chosen to attack a particular waste material can also be engineered using the technology described herein. Exemplary waste materials include toxic waste, organic waste, hazardous waste, and non-toxic waste.

Medications, skin patches, fertilizers, herbicides, insecticides, etc. all typically use carriers blended with additives. Utilization of the technology described herein reduces the amount of additives used (and the cost) while increasing efficacy.

Most dry household products such as soaps, detergents, etc. could be engineered to be lighter, stronger, longer lasting, or cheaper using the clay aerogel technology as discussed herein.

Composite particles can be dry mixed with additives including, but not limited to, particles of activated carbon.

Various absorbent compositions, including aerogels derived from various components, were tested comparatively with a commercial litter mixture. Absorbent aerogel samples were prepared by creating a solution of the polymer of interest, as indicated in Table 1 below, in water at the desired concentration. To 50 mL water, each polymer when present and 2.5 g of montmorillonite clay (PGW, Nanocor Inc.) was added and the combined mixture was put into a Waring model MC2 mini laboratory blender. For the sample compositions set forth in Tables 1, 3 and 4, the PGW clay was present in an amount of 5.0 parts per 100 parts water, and the polymer was present in the amounts indicated based on 100 parts water. For example, in the first sample listed in Table 1, the 10% PEG 4600 Aerogel was formed from a composition comprising 50 mL water, 5 grams PEG 4600 (weight average molecular weight) and 2.5 grams clay. Therefore, on a dry weight basis, the weight of polymer was twice that of the clay. The mixture was blended on the high speed setting for approximately 30 seconds, after which it was poured/scooped into 5 dram poly(styrene) vials (Fisherbrand, 033383B). A mixture of solid carbon dioxide and ethanol was used to freeze the samples.

Five percent (5%) PGW aerogel samples were prepared by adding 2.5 g of clay to 50 mL of water and blending in the mini blender for 30 seconds and then freezing using the dry ice ethanol bath.

The frozen samples were kept in a laboratory freezer, approximately −12° C. until all samples had been frozen and were ready for freeze-drying. Freeze drying was carried out using a Virtis Advantage EL-85 lyophilizer with an initial shelf temperature of −10° C., condenser temperature of −80° C. and eventual 10 μbar vacuum. Samples were placed on the shelf and the vacuum was applied on and allowed to reach 1 μbar before the shelf was heated to 25° C. Samples were left in the chamber for four days to insure complete drying.

Some of the formed 5% PGW aerogels were fired using a Sentro Tech 1200° C. box furnace heating at approximately 2° C./minute from 30-875° C. as read on the furnace thermocouple. The samples were held at 875° C. for one hour and then allowed to cool to room temperature without assistance. The cooling process took approximately 12 hours. The firing process produced clay aerogel-based porous ceramics.

A small piece of each sample was weighed and placed into a glass vial. The vial and sample were weighed and water was added dropwise by pipette until the sample stopped absorbing the water. This point was determined by visually inspecting the sample inside the vial and if any standing water or loose water was visible, it was determined that the sample was saturated. The system was again weighed to determine the amount of water taken into the sample. While the end of the experiment was determined by seeing the minute excess of water that was not absorbed into the sample, the amount was typically minuscule and, therefore, the entire added mass of water was used to calculate the absorption.

TABLE 1
Summary of Results for Water Absorption

| | | Water | Water |
|---|---|---|---|
| | Density | Absorbed | Absorbed |
| Sample | (g/cm³) | (g/g) | (g/cm³) |
| 10% PEG 4600¹ Aerogel | 0.122 | 2.15 | 0.26 |
| 5% PEG 35K¹ Aerogel | 0.080 | 3.18 | 0.25 |
| 1% Poly(Acrylic Acid) | 0.054 | 5.82 | 0.32 |
| Aerogel | | | |
| Fired 5% PGW Aerogel | 0.06 | 14.03 | 0.84 |
| Fresh Step Scoop ® | 1.1 | 1.42 | 1.56 |

¹weight average molecular weight

As evident from Table 1, the absorbent aerogel compositions absorbed more water per gram of sample when compared to the commercial litter.

In order to investigate the effect of ionic strength on the absorption properties, a mixture of artificial urine was made (see Table 2) and tested on the compositions set forth in Table 3.

TABLE 2
Composition of Artificial Urine

| Component | Weight % |
|---|---|
| Urea | 1.95 |
| NaCl | 0.85 |
| MgSO₄ | 0.11 |
| CaCl | 0.06 |
| Water | 97.03 |

TABLE 3
Summary of Results for Artificial Urine Absorption

| | | Urine | Urine |
|---|---|---|---|
| | Density | Absorbed | Absorbed |
| Sample | (g/cm³) | (g/g) | (g/cm³) |
| 10% PEG 4600¹ Aerogel | 0.119 | 3.02 | 0.36 |
| 5% PEG 35K¹ Aerogel | 0.080 | 3.90 | 0.35 |
| 1% Poly(Acrylic Acid) | 0.061 | 6.43 | 0.39 |
| Aerogel | | | |
| Fired 5% PGW Aerogel | 0.104 | 13.26 | 1.38 |
| Fired 5% PGW Aerogel | 0.082 | 13.34 | 1.09 |
| Fresh Step Scoop ® | 1.1 | 1.53 | 1.68 |

¹weight average molecular weight

As evident from Table 3, the absorbent aerogel compositions of the present invention absorb more artificial urine per gram when compared to the commercial litter formulation.

Absorbent compositions including clay aerogels having relatively higher solids content and a fiber reinforced clay aerogel that contains soysilk fibers about 3 mL in length was also tested. In Table 4 below, Al-30 is a grade of Torlon® polyamide-imide produced by Solvay Advanced Polymers. The results are set forth in Table 4.

TABLE 4

| | | Water | Water |
|---|---|---|---|
| | Density | Absorbed | Absorbed |
| Sample | (g/cm³) | (g/g) | (g/cm³) |
| 10% PGW 20% PVOH Aerogel | 0.340 | 1.63 | 0.20 |
| 5% PGW 10% PVOH Aerogel | 0.124 | 3.61 | 0.44 |
| 5% PGW 10% PEO (35K) Aerogel | 0.134 | 1.97 | 0.24 |
| 5% PGW 1.5% AI-30 Aerogel | 0.074 | 4.59 | 0.56 |
| 5% PGW 2.5% PVOH 5% Soysilk | 0.128 | 6.22 | 0.76 |
| Aerogel | | | |

As illustrated in Table 4, the fiber reinforced clay aerogel exhibited desirable water absorption. It was found that the fiber containing aerogel was able to rapidly uptake water and also retain its shape after saturation.

Examples show that the aerogels of the present invention, whether aerogel compositions and/or clay aerogel-based porous ceramics are relatively low density materials that can absorb water rapidly while remaining free-flowing particles. Absorbent compositions comprising the aerogels in one or more additives are suitable for use in absorbent applications, such as kitty litter.

In one embodiment, a clay aerogel polymer composite is disclosed, comprising: the composite derived from a) an aerogel derived from at least clay, b) two or more monomers that are the same or different, c) an initiator, and d) a binder component, and optionally a cross-linker, wherein the monomers are polymerized in the presence of the clay aerogel. In one embodiment, the binder component is polyvinyl alcohol, a polymer or copolymer derived from two or more same or different alkylene oxide monomers having from 2 to about 6 carbon atoms, or a copolymer derived from at least one alkylene oxide having from 2 to about 6 carbon atoms and an amine, or a combination thereof, wherein the initiator is azo compounds, peroxides, Fenton's Reagent, and benzophone or other photo-initiated agents. In another embodiment the clay is present in an amount from about 1 to about 40 parts per 100 parts by weight of the composite, wherein the polymer is present in an amount from about 1 to about 60 parts by weight per 100 parts by weight of the composite, and wherein the binder component is present in an amount from about 0.5 to about 25 parts by weight per 100 parts by weight of the composite. In yet another embodiment the clay is present in an amount from about 1 to about 30 parts per 100 parts by weight of the composite, wherein the polymer is present in an amount from about 1 to about 30 parts by weight per 100 parts by weight of the composite, and wherein the binder component is present in an amount from about 1 to about 10 parts by weight per 100 parts by weight of the composite. In another embodiment the (co)polymer is a water soluble (co)polymer. In a further embodiment the water soluble (co)polymer is a starch, plant gum, modified cellulosic, lignin material, chitan, chitosan, pectin, a water soluble and dispersible protein, or combinations thereof. In yet another embodiment the binder component is polyvinyl alcohol or a polymer or copolymer derived from two or more same or different alkylene oxide monomers having from 2 to about 6 carbon atoms, or a combination thereof. In another embodiment the (co)polymer is derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups, or combinations thereof. In still another embodiment the (co)polymer is corn starch, potato starch, amaranth starch, arrowroot starch, banana starch, barley starch, cassava starch, millet starch, oat starch, rice starch, rye starch, sago starch, sorghum starch, sweet potato starch, wheat starch or yam starch or combinations thereof. Combinations of the embodiments are envisioned.

In a further embodiment a process for preparing a clay aerogel polymer composite is disclosed, comprising the steps of: combining a) an aerogel derived from at least clay, b) two or more same or different monomers, c) an initiator, and d) a binder component in a solvent to form a solution; and polymerizing the monomers and removing the solvent to produce the clay aerogel polymer composite. In one embodiment the binder component is polyvinyl alcohol, a polymer or copolymer derived from two or more same or different alkylene oxide monomers having from 2 to about 6 carbon atoms, or a copolymer derived from at least one alkylene oxide having from 2 to about 6 carbon atoms and an amine, or a combination thereof. In another embodiment the clay is present in an amount from about 1 to about 40 parts per 100 parts by weight of the composite, wherein the polymer is present in an amount from about 1 to about 60 parts by weight per 100 parts by weight of the composite, and wherein the binder component is present in an amount from about 0.5 to about 25 parts by weight per 100 parts by weight of the composite. In yet another embodiment the clay is present in an amount from about 1 to about 30 parts per 100 parts by weight of the composite, wherein the polymer is present in an amount from about 1 to about 30 parts by weight per 100 parts by weight of the composite, and wherein the binder component is present in an amount from about 1 to about 10 parts by weight per 100 parts by weight of the composite. In yet another embodiment the (co)polymer is a water soluble (co)polymer. In a further embodiment the water soluble (co)polymer is a starch, plant gum, modified cellulosic, lignin material, chitan, chitosan, pectin, a water soluble and dispersible protein, or combinations thereof. In another embodiment the binder component is polyvinyl alcohol or a polymer or copolymer derived from two or more same or different alkylene oxide monomers having from 2 to about 6 carbon atoms, or a combination thereof. In another embodiment the (co)polymer is derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups, or combinations thereof. In a further embodiment the (co)polymer is corn starch, potato starch, amaranth starch, arrowroot starch, banana starch, barley starch, cassava starch, millet starch, oat starch, rice starch, rye starch, sago starch, sorghum starch, sweet potato starch, wheat starch or yam starch or combinations thereof. Combinations of the embodiments are envisioned.

In a further embodiment a clay aerogel-based porous ceramic is disclosed comprising: a ceramic structure derived from an aerogel composition formed by heating to a temperature greater than or equal to 400° C. for a length of time sufficient to produce the clay aerogel-based porous ceramic. In another embodiment the aerogel is derived from clay and a (co)polymer or binder component, or combinations thereof. In another embodiment the binder component is polyvinyl alcohol, a polymer or copolymer derived from two or more same or different alkylene oxide monomers having from 2 to about 6 carbon atoms, or a copolymer derived from at least one alkylene oxide having from 2 to about 6 carbon atoms and an amine, or a combination thereof. In a further embodiment the clay is present in an amount from about 1 to about 40 parts per 100 parts by weight of the composite, wherein the polymer is present in an amount from about 1 to about 60 parts by weight per 100 parts by weight of the composite, and wherein the binder component is present in an amount from about 0.5 to about 25 parts by weight per 100 parts by weight of the composite. In yet a further embodiment the clay is present in an amount from about 1 to about 30 parts per 100 parts by weight of the composite, wherein the polymer is present in an amount from about 1 to about 30 parts by weight per 100 parts by weight of the composite, and wherein the binder component is present in an amount from about 1 to about 10 parts by weight per 100 parts by weight of the composite. In a further embodiment the (co)polymer is a water soluble (co)polymer. In a further embodiment the water soluble (co)polymer is a starch, plant gum, modified cellulosic, lignin material, chitan, chitosan, pectin, a water soluble and dispersible protein, or combinations thereof. In yet another embodiment the binder component is polyvinyl alcohol or a polymer or copolymer derived from two or more same or different alkylene oxide monomers having from 2 to about 6 carbon atoms, or a combination thereof. In another embodiment the (co)polymer is derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups, or combinations thereof. In yet a further embodiment the (co)polymer is corn starch, potato starch, amaranth starch, arrowroot starch, banana starch, barley starch, cassava starch, millet starch, oat starch, rice starch, rye starch, sago starch, sorghum starch, sweet potato starch, wheat starch or yam starch or combinations thereof. Combinations of the embodiments are envisioned.

In a further embodiment a clay aerogel-based porous ceramic is disclosed comprising: providing an aerogel and heating the aerogel for a sufficient period of time to a temperature above 400° C. to produce the clay aerogel-based porous ceramic. In a further embodiment the aerogel is derived from clay and a (co)polymer or binder component, or combinations thereof, wherein the binder component is polyvinyl alcohol, a polymer or copolymer derived from two or more same or different alkylene oxide monomers having from 1 to about 6 carbon atoms, or a copolymer derived from at least one alkylene oxide having from 2 to about 6 carbon atoms and an amine, or a combination thereof. In another embodiment the clay is present in an amount from about 1 to about 40 parts per 100 parts by weight of the composite, wherein the polymer is present in an amount from about 1 to about 60 parts by weight per 100 parts by weight of the composite, and wherein the binder component is present in an amount from about 0.5 to about 25 parts by weight per 100 parts by weight of the composite. In another embodiment the clay is present in an amount from about 1 to about 30 parts per 100 parts by weight of the composite, wherein the polymer is present in an amount from about 1 to about 30 parts by weight per 100 parts by weight of the composite, and wherein the binder component is present in an amount from about 1 to about 10 parts by weight per 100 parts by weight of the composite. In a further embodiment the (co)polymer is a water soluble (co)polymer. In yet another embodiment the water soluble (co)polymer is a starch, plant gum, modified cellulosic, lignin material, chitan, chitosan, pectin, a water soluble and dispersible protein, or combinations thereof. In a further embodiment the binder component is polyvinyl alcohol or a polymer or copolymer derived from two or more same or different alkylene oxide monomers having from 2 to about 6 carbon atoms, or a combination thereof. In another embodiment the (co)polymer is derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups, or combinations thereof. In yet another embodiment the (co)polymer is corn starch, potato starch, amaranth starch, arrowroot starch, banana starch, barley starch, cassava starch, millet starch, oat starch, rice starch, rye starch, sago starch, sorghum starch, sweet potato starch, wheat starch or yam starch or combinations thereof. Combinations of the embodiments are envisioned.

In a further embodiment an article is disclosed comprising: a clay aerogel polymer composite layer and a second layer. In a further embodiment the second layer is a natural material, a synthetic material, or combinations thereof. In another embodiment the synthetic material is a polymer or (co)polymer film layer. In another embodiment the clay aerogel polymer composite comprises a clay; a (co)polymer; and a binder component, wherein the clay is present in an amount from about 1 to about 99 parts per 100 parts by weight of the composite, wherein the polymer is present in an amount from about 1 to about 99 parts by weight per 100 parts by weight of the composite, and wherein the binder component is present in an amount from about 0.1 to about 40 parts by weight per 100 parts by weight of the composite. In a further embodiment the binder component is polyvinyl alcohol, a polymer or copolymer derived from two or more same or different alkylene oxide monomers having from 2 to about 6 carbon atoms, or a copolymer derived from at least one alkylene oxide having from 2 to about 6 carbon atoms and an amine, or a combination thereof. In yet a further embodiment the clay is present in an amount from about 1 to about 40 parts per 100 parts by weight of the composite, wherein the polymer is present in an amount from about 1 to about 60 parts by weight per 100 parts by weight of the composite, and wherein the binder component is present in an amount from about 0.5 to about 25 parts by weight per 100 parts by weight of the composite. In a further embodiment the clay is present in an amount from about 1 to about 30 parts per 100 parts by weight of the composite, wherein the polymer is present in an amount from about 1 to about 30 parts by weight per 100 parts by weight of the composite, and wherein the binder component is present in an amount from about 1 to about 10 parts by weight per 100 parts by weight of the composite. In another embodiment the (co)polymer is a water soluble (co)polymer. In another embodiment the water soluble (co)polymer is a starch, plant gum, modified cellulosic, lignin material, chitan, chitosan, pectin, a water soluble and dispersible protein, or combinations thereof. In still another embodiment the binder component is polyvinyl alcohol or a polymer or copolymer derived from two or more same or different alkylene oxides having from 2 to about 6 carbon atoms, or a combination thereof. In another embodiment the (co)polymer is derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups, or combinations thereof. In a further embodiment the (co)polymer is corn starch, potato starch, amaranth starch, arrowroot starch, banana starch, barley starch, cassava starch, millet starch, oat starch, rice starch, rye starch, sago starch, sorghum starch, sweet potato starch, wheat starch or yam starch or combinations thereof. Combinations of the embodiments are envisioned.

In a further embodiment a clay aerogel is disclosed comprising: a clay; and a water soluble salt in an amount from about 0.05 to about 20 parts by weight per 100 parts by weight of the clay. In another embodiment the salt is present in an amount from about 0.05 to about 10 parts by weight. In a further embodiment the aerogel further includes a (co)polymer or a binder component, or combinations thereof. In yet another embodiment the binder component is polyvinyl alcohol, a polymer or copolymer derived from two or more same or different alkylene oxide monomers having from 2 to about 6 carbon atoms, or a copolymer derived from at least one alkylene oxide having from 2 to about 6 carbon atoms and an amine, or a combination thereof. In a further embodiment the clay is present in an amount from about 1 to about 40 parts per 100 parts by weight of the composite, wherein the polymer is present in an amount from about 1 to about 60 parts by weight per 100 parts by weight of the composite, and wherein the binder component is present in an amount from about 0.5 to about 25 parts by weight per 100 parts by weight of the composite. In a further embodiment the clay is present in an amount from about 1 to about 30 parts per 100 parts by weight of the composite, wherein the polymer is present in an amount from about 1 to about 30 parts by weight per 100 parts by weight of the composite, and wherein the binder component is present in an amount from about 1 to about 10 parts by weight per 100 parts by weight of the composite. In another embodiment the (co)polymer is derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups, or combinations thereof. In yet a further embodiment the (co)polymer is corn starch, potato starch, amaranth starch, arrowroot starch, banana starch, barley starch, cassava starch, millet starch, oat starch, rice starch, rye starch, sago starch, sorghum starch, sweet potato starch, wheat starch or yam starch or combinations thereof. Combinations of the embodiments are envisioned.

It will be understood by those who practice the invention and those skilled in the art that various modifications and improvements may be made to the invention without departing from the spirit of the disclosed concept. The scope of protection afforded is to be determined by the claims and by the breadth of interpretation allowed by law.

What is claimed is:

1. An absorbent composition, comprising:
particles of an absorbent porous clay aerogel comprising one or more of (a) an aerogel component derived from at least a clay and one or more of (i) a (co)polymer and (ii) binder component and (b) a clay aerogel-based porous ceramic derived from at least the aerogel component; and an additive material in contact with at least one clay aerogel particle and comprising one or more of a clumping agent, an antimicrobial agent, a pH-adjusting agent, a fragrance, a deodorant, an odor-control agent, a coloring agent, a dedusting agent, a urease inhibition agent and a non-aerogel absorbent material.

2. The absorbent composition according to claim 1, wherein the clay aerogel further comprises one or more fibers, wherein when two or more fibers are present the fibers can be the same or different, and wherein the fibers are natural or synthetic or a combination thereof.

3. The absorbent composition according to claim 2, wherein the one or more fibers are present in an amount from about 0.25 to about 1,250 parts per 100 parts by weight of clay in the clay aerogel.

4. The absorbent composition according to claim 3, wherein the one or more fibers are derived from one or more of polyvinyl alcohol, a polymer or (co)polymer possessing a high concentration of pendant carboxylic acids, and a polymer or (co)polymer which contains one or more amide bonds.

5. The absorbent composition according to claim 1, wherein the (co)polymer is present and is a water soluble (co)polymer comprising one or more of starch, plant gum, modified cellulosic, lignin material, chitan, chitosan, pectin, a water soluble and dispersible protein, or derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups; or a combination of the water soluble (co)polymer and copolymer derived from two or more same or different monomers.

6. The absorbent composition according to claim 1, wherein the binder component is present and is polyvinyl alcohol, a polymer or copolymer derived from two or more same or different alkylene oxide monomers having from 2 to about 6 carbon atoms, a copolymer derived from at least one alkylene oxide having from 2 to about 6 carbon atoms and an amine, or a polyoxymethylene polymer or copolymer, or a combination thereof.

7. The absorbent composition according to claim 1, wherein the antimicrobial agent is present and comprises a boron-containing compound.

8. The absorbent composition according to claim 1, wherein the clumping agent is present and includes one or more of lignin sulfonate, fibrillated polytetrafluoroethylene, hydroxymethyl cellulose, a carboxymethyl cellulose derivative, a metal salt, guar gum cellulose, xanthan gum, starch, lignin, polyvinyl alcohol, polyacrylic acid, styrene butadiene resins, polystyrene acrylic acid resin and crosslinked polyester.

9. The absorbent composition according to claim 1, wherein the dedusting agent is present and wherein the dedusting agent is one or more of gums, water-soluble polymeric resins, and a gum or natural resin.

10. The absorbent composition according to claim 1, wherein the composition includes one or more of the coloring agent, fragrance and odor control agent.

11. The absorbent composition according to claim 1, wherein the composition includes the urease inhibition agent.

12. The absorbent composition according to claim 1, wherein the composition includes a non-aerogel absorbent material.

13. The absorbent composition according to claim 1, wherein the composition includes activated alumina in an amount from about 0.01 part to about 50 parts by weight based on 100 total parts by weight of the composition.

14. The absorbent composition according to claim 1, wherein the additive material comprises particles dry blended with the clay aerogel particles.

15. The absorbent composition according to claim 1, wherein the additive material is coated on a surface of at least one of the clay aerogel particles.

16. A reinforced clay aerogel, comprising:
one or more of (a) a porous clay aerogel component derived from at least a clay, one or more fibers and one or more of (i) a copolymer and (ii) a binder component and (b) a clay aerogel-based porous ceramic derived from the porous clay aerogel component.

17. The reinforced clay aerogel according to claim 16, wherein when two or more fibers are present, the fibers can be the same or different, wherein the fibers are natural or synthetic or a combination thereof.

18. The reinforced clay aerogel according to claim 16, wherein the one or more fibers are present in an amount from about 0.25 to about 1,250 parts per 100 parts by weight of clay in the clay aerogel.

19. The reinforced clay aerogel according to claim 16, wherein the one or more fibers are derived from one or more of polyvinyl alcohol, a polymer or (co)polymer possessing a high concentration of pendant carboxylic acids, and a polymer or (co)polymer which contains one or more amide bonds.

20. The reinforced clay aerogel according to claim 16, wherein the (co)polymer is present and is a water soluble (co)polymer comprising one or more of starch, plant gum, modified cellulosic, lignin material, chitan, chitosan, pectin, a water soluble and dispersible protein, or derived from two or more same or different monomers comprising an olefin monomer, styrene, isoprene, butadiene, a cyclic olefin, a halogenated monomer, chlorinated isoprene, vinyl fluoride, vinylidene fluoride, acrylic monomer, vinyl acetate, an amine group containing monomer, aliphatic dialcohol, aromatic dialcohol, diamine, diisocyanate, dicarboxylic acid, a difunctional monomer containing one carboxylic acid and either one alcohol or amino group, arylene oxide, arylene sulfide, arylene sulfone, and a monomer having one or more epoxy groups; or a combination of the water soluble (co)polymer and copolymer derived from two or more same or different monomers.

21. The reinforced clay aerogel according to claim 16, wherein the binder component is present and is polyvinyl alcohol, a polymer or copolymer derived from two or more same or different alkylene oxide monomers having from 2 to about 6 carbon atoms, or a copolymer derived from at least one alkylene oxide having from 2 to about 6 carbon atoms and an amine, a polyoxymethylene polymer or copolymer, or a combination thereof.

22. The reinforced clay aerogel according to claim 4, wherein the fibers are derived from a composition comprising one or more of polyvinyl alcohol, poly(acrylic acid), poly(methylacrylic acid), Nylon-6, Nylon-6,6, silk and soy silk, or (co)polymers or combinations thereof.

23. The reinforced clay aerogel according to claim 19, wherein the fibers are derived from a composition comprising one or more of polyvinyl alcohol, poly(acrylic acid), poly(methylacrylic acid), Nylon-6, Nylon-6,6, silk and soy silk, or (co)polymers or combinations thereof.
